(19) United States
(12) Patent Application Publication
(10) Pub. No.: US 2026/0322142 A1
(43) Pub. Date: Oct. 15, 2026

(54) CHARGING ABNORMALITY DETECTION CIRCUIT AND CHARGING ABNORMALITY DETECTION METHOD

(71) Applicant: QISDA CORPORATION, Taoyuan City (TW)

(72) Inventor: Sheng-Hsiang Hsieh, Taoyuan City (TW)

(21) Appl. No.: 19/636,973

(22) Filed: Apr. 2, 2026

(30) Foreign Application Priority Data
Apr. 11, 2025 (CN) 202510453373.2

(51) Int. Cl. H02J 7/62; G06F 1/28; H02J 7/64; H02J 7/65; H02J 7/80

(52) U.S. Cl. CPC H02J 7/62; G06F 1/28; H02J 7/64; H02J 7/65; H02J 7/80

(57) ABSTRACT

A charging abnormality detection circuit and a method thereof. The charging abnormality detection circuit is mounted in a first electronic device, and the charging abnormality detection circuit comprises an image processing unit and a power transmission unit. The power transmission unit is electrically connected to the image processing unit, and the power transmission unit provides a charging process from the first electronic device to a second electronic device and detect whether a charging abnormality condition occurs during the charging process. The power transmission unit generates and stores a charging abnormality record in response to the charging abnormality condition being detected by the power transmission unit during the charging process.

### CROSS-REFERENCE TO RELATED PATENT APPLICATION

This application claims the benefit of priority to China Patent Application No. 202510453373.2, filed on Apr. 11, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a charging circuit and a charging method, and more particularly to a charging circuit and a charging method for monitoring whether abnormal conditions occur during a charging process.

### BACKGROUND OF THE DISCLOSURE

Whether for work or for entertainment, there is a clear upward trend for time spent on using electronic products. Therefore, whether electronic products support fast charging has become an important consideration for consumers making a purchase.

The latest Universal Serial Bus (USB) has the function of Power Delivery (PD). A user uses the USB Port and USB Cable to connect two electronic products so that one of the two electronic products can charge the other of the two electronic products. However, when an abnormal charging condition occurs during a charging process, the user cannot know that an abnormality has occurred, and if continued to be used, it will cause permanent damage to the electronic product.

Therefore, it is necessary to design a new charging circuit and charging method to monitor whether an abnormal condition occurs during the charging process to overcome the above problems.

### SUMMARY OF THE DISCLOSURE

In response to the above-referenced technical inadequacies, the present disclosure provides a charging abnormality detection circuit and a charging abnormality detection method.

In order to solve the above-mentioned problems, one of the technical aspects adopted by the present disclosure is to provide a charging abnormality detection circuit. The charging abnormality detection circuit is mounted in a first electronic device and the charging abnormality detection circuit comprises an image processing unit and a power transmission unit. The power transmission unit is electrically connected to the image processing unit, and the power transmission unit provides a charging process from the first electronic device to a second electronic device and detect whether a charging abnormality condition occurs during the charging process. The power transmission unit generates and stores a charging abnormality record in response to the charging abnormality condition being detected by the power transmission unit during the charging process.

In one of the possible or preferred embodiments, the image processing unit obtains and stores the charging abnormality record from the power transmission unit, and the image processing unit displays the charging abnormality record through a menu displayed on a screen of the first electronic device and/or through a display operation interface of the second electronic device.

In one of the possible or preferred embodiments, the power transmission unit comprises a register for storing the charging abnormality record, and the image processing unit obtains and stores the charging abnormality record from the register.

In one of the possible or preferred embodiments, the image processing unit sends a command based on a display data channel command interface, so as to transmit the charging abnormality record to the second electronic device according to a request command of the second electronic device, and the second electronic device displays the charging abnormality record.

In one of the possible or preferred embodiments, the power transmission unit comprises a control unit, a voltage detection unit and a current detection unit. The control unit is electrically connected to the voltage detection unit and the current detection unit, the voltage detection unit detects a charging voltage of the charging process to generate a voltage detection signal, and the current detection unit detects a charging current of the charging process to generate a current detection signal. The control unit determines whether the voltage detection signal is greater than a voltage threshold, when the voltage detection signal is greater than the voltage threshold, the control unit determines that the charging abnormality condition occurs during the charging process and generates a voltage abnormality record. The control unit further determines whether the current detection signal is greater than a current threshold; when the current detection signal is greater than the current threshold, the control unit determines that the charging abnormality condition occurs and generates a current abnormality record, wherein the charging abnormality record comprises the voltage abnormality record and the current abnormality record.

In one of the possible or preferred embodiments, the power transmission unit further comprises a control unit, a temperature detection unit and a short circuit detection unit; the control unit is electrically connected to the temperature detection unit and the short circuit detection unit. The temperature detection unit is configured to detect a temperature of the charging process to generate a temperature detection signal, and the control unit determines whether the temperature detection signal is greater than a temperature threshold; when the temperature detection signal is greater than the temperature threshold, the control unit determines that the charging abnormality condition occurs and generates a temperature abnormality record. The short circuit detection unit detects whether a short circuit occurs during the charging process of the first electronic device to the second electronic device; when the short circuit detection unit detects that the short circuit occurs during the charging process, the control unit determines that the charging abnormality condition occurs and generates a short circuit abnormality record, wherein the charging abnormality record further comprises the temperature abnormality record and the short circuit abnormality record.

In one of the possible or preferred embodiments, the charging abnormality detection circuit further comprises an electrical connection unit and a protection unit, wherein the electrical connection unit is electrically connected to the second electronic device through a charging cable, and the protection unit is electrically connected between the electrical connection unit and the power transmission unit.

In one of the possible or preferred embodiments, when the charging abnormality condition occurs during the charging process, the protection unit transmits a charging abnormality signal to the power transmission unit.

In one of the possible or preferred embodiments, the charging abnormality detection circuit further comprises a wireless charging transmitter and a protection unit, and the second electronic device comprises a wireless charging receiver. The wireless charging transmitter and the wireless charging receiver perform the charging process through a resonant wireless transmission mechanism, and the protection unit is electrically connected to the wireless charging transmitter and the power transmission unit.

In one of the possible or preferred embodiments, when the charging abnormality condition occurs during the charging process, the protection unit transmits a charging abnormality signal to the power transmission unit.

In order to solve the above-mentioned problems, another one of the technical aspects adopted by the present disclosure is to provide a charging abnormality detection method. The charging abnormality detection method is applied to a first electronic device and the charging abnormality detection method comprises: monitoring, by a power transmission unit of the first electronic device, a charging process from the first electronic device to a second electronic device; detecting, by the power transmission unit, whether a charging abnormality condition during the charging process; and generating and storing, by the transmission unit, a charging abnormality record in response to the charging abnormality condition being detected by the power transmission unit during the charging process.

In one of the possible or preferred embodiments, the charging abnormality detection method further comprises: obtaining and storing, by an image processing unit of the first electronic device, the charging abnormality record from the power transmission unit; and displaying the charging abnormality record through a menu displayed on a screen of the first electronic device and/or through a display operation interface of the second electronic device.

In one of the possible or preferred embodiments, the power transmission unit comprises a register for storing the charging abnormality record, and an image processing unit is configured to obtain and store the charging abnormality record from the register.

In one of the possible or preferred embodiments, the charging abnormality detection method further comprises: sending, by an image processing unit of the first electronic device, a command based on a display data channel command interface; transmitting, by an image processing device, the charging abnormality record to the second electronic device according to a request command of the second electronic device in response to the image processing unit sending the command; and displaying the charging abnormality record by the second electronic device in response to the image processing unit sending the command.

In one of the possible or preferred embodiments, monitoring the charging process by the power transmission unit comprises: detecting, by a voltage detection unit of the power transmission unit, a charging voltage of the charging process to generate a voltage detection signal; detecting, by a current detection unit of the power transmission unit, a charging current of the charging process to generate a current detection signal; determining, by a control unit of the power transmission unit, whether the voltage detection signal is greater than a voltage threshold; determining that the charging abnormality condition occurs during the charging process and generating a voltage abnormality record by the control unit when the voltage detection signal is greater than the voltage threshold; determining, by the control unit, whether the current detection signal is greater than a current threshold; and determining that the charging abnormality condition occurs and generating a current abnormality record by the control unit when the current detection signal is greater than the current threshold; wherein the charging abnormality record comprises the voltage abnormality record and the current abnormality record.

In one of the possible or preferred embodiments, monitoring the charging process by the power transmission unit comprises: detecting, by a temperature detection unit of the power transmission unit, a temperature of the charging process to generate a temperature detection signal; determining, by a control unit of the power transmission unit, whether the temperature detection signal is greater than a temperature threshold; determining that the charging abnormality condition occurs and generating a temperature abnormality record by the control unit when the temperature detection signal is greater than the temperature threshold; detecting, by a short circuit detection unit of the power transmission unit, whether a short circuit occurs during the charging process; and determining that the charging abnormality condition occurs and generating a short circuit abnormality record by the control unit when the short circuit occurs during the charging process; wherein the charging abnormality record further comprises the temperature abnormality record and the short circuit abnormality record.

In one of the possible or preferred embodiments, the first electronic device performs the charging process on the second electronic device through an electrical connection unit and a charging cable.

In one of the possible or preferred embodiments, when the charging abnormality condition occurs during the charging process, a protection unit of the first electronic device transmits a charging abnormality signal to the power transmission unit.

In one of the possible or preferred embodiments, the charging process is performed between the first electronic device and the second electronic device through a resonant wireless transmission mechanism.

In one of the possible or preferred embodiments, when the charging abnormality condition occurs during the charging process, a protection unit of the first electronic device transmits a charging abnormality signal to the power transmission unit.

In one of the possible or preferred embodiments, a charging abnormality detection method applied to a first electronic device comprises: monitoring, by the first electronic device, a charging process from the first electronic device to a second electronic device; detecting, by the first electronic device, whether a charging abnormality condition occurs during the charging process; and generating and storing, by the first electronic device, a charging abnormality record in response to the charging abnormality condition being detected by the first electronic device during the charging process.

In one of the possible or preferred embodiments, a monitoring the charging process comprises: detecting a temperature of the charging process to generate a temperature detection signal; determining whether the temperature detection signal is greater than a temperature threshold; and, determining that the charging abnormality condition occurs and generating a temperature abnormality record when the temperature detection signal is greater than the temperature threshold.

Therefore, in the charging abnormality detection circuit and the charging abnormality detection method provided by the present disclosure, during the charging process of the electronic device, a user can know whether abnormal conditions occur during the charging process. When the user is made aware of the abnormal conditions during the charging process, the user can stop the charging process immediately to avoid damage to the electronic device.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a charging abnormality detection circuit according to a first embodiment of the present disclosure;

FIG. 2 is a functional block diagram of the charging abnormality detection circuit according to a second embodiment of the present disclosure;

FIG. 3 is a functional block diagram of the charging abnormality detection circuit according to a third embodiment of the present disclosure;

FIG. 4 is a functional block diagram of the charging abnormality detection circuit according to a fourth embodiment of the present disclosure;

FIG. 5 is a functional block diagram of the charging abnormality detection circuit according to a fifth embodiment of the present disclosure;

FIG. 6 is a functional block diagram of the charging abnormality detection circuit according to a sixth embodiment of the present disclosure;

FIG. 7A and FIG. 7B present a flowchart of a charging abnormality detection method according to the first embodiment of the present disclosure; and

FIG. 8A and FIG. 8B present a flowchart of the charging abnormality detection method according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” comprises plural reference, and the meaning of “in” comprises “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

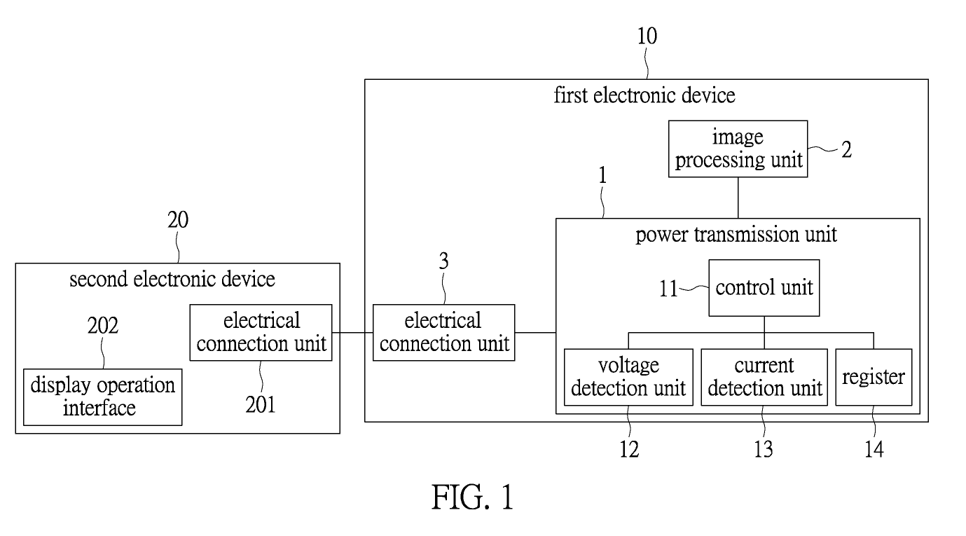

FIG. 1 is a functional block diagram of a charging abnormality detection circuit according to a first embodiment of the present disclosure. Referring to FIG. 1, the charging abnormality detection circuit is disposed in a first electronic device 10, and comprises a power transmission unit 1, an image processing unit 2, and an electrical connection unit 3. The power transmission unit 1 is electrically connected to the image processing unit 2 and the electrical connection unit 3.

For example, the first electronic device 10 is a display, the power transmission unit 1 is a universal serial bus power delivery integrated circuit (USB Power Delivery IC), the image processing unit 2 is a display control integrated circuit, and the display control integrated circuit comprises an image scaling circuit, an analog-to-digital converter (ADC) circuit, a phase locked loop (PLL) circuit, and an on-screen display (OSD) circuit. The control integrated circuit of the display is electrically connected to a driver integrated circuit of the display. The control integrated circuit is responsible for receiving signals from the computer and for converting and processing image signals, while the driver integrated circuit is responsible for outputting and displaying image signals. The output signal of the driver integrated circuit is transmitted to a panel of the display. The electrical connection unit 3 is a USB Type C port. A second electronic device 20 is a laptop, an electrical connection unit 201 of the second electronic device 20 is a USB Type C port, and a charging cable is a USB Type C transmission cable. When two ends of the charging cable are respectively connected to the electrical connection unit 3 of the first electronic device 10 and the electrical connection unit 201 of the second electronic device 20, the power transmission unit 1 provides a charging process from the first electronic device 10 to the second electronic device 20.

The power transmission unit 1 detects whether a charging abnormality condition occurs during the charging process from the first electronic device 10 to the second electronic device 20. In response to the charging abnormality condition being detected by the power transmission unit 1 during the charging process, the power transmission unit 1 generates and stores a charging abnormality record.

The power transmission unit 1 comprises a control unit 11, a voltage detection unit 12, a current detection unit 13 and a register 14, and the control unit 11 is electrically connected to the voltage detection unit 12, the current detection unit 13 and the register 14. The control unit 11 is, for example, a programmable logic controller circuit (PLC), a micro-processor circuit (MCU), a micro-control circuit (MCU), a field programmable gate array (FPGA), a complex programmable logic device (CPLD), an application specific integrated circuit (ASIC), or other processors or controllers with signal processing functions.

The voltage detection unit 12 is a voltage detection circuit and detects a charging voltage of the first electronic device 10 charging the second electronic device 20 to generate a voltage detection signal. The control unit 11 determines whether the voltage detection signal is greater than a voltage threshold. When the voltage detection signal is greater than the voltage threshold, the control unit 11 determines that the charging abnormality condition occurs and generates a voltage abnormality record. In other words, the charging abnormality condition is an overvoltage, and the control unit 11 stores the voltage abnormality record in the register 14. In one embodiment, the voltage detection unit 12 determines whether the charging abnormality condition occurs earlier than the current detection unit 13. In one embodiment, the current detection unit 13 determines whether the charging abnormality condition occurs earlier than the voltage detection unit 12. In one embodiment, the voltage detection unit 12 and the current detection unit 13 simultaneously determine whether the charging abnormality condition occurs.

The current detection unit 13 is a current detection circuit and detects a charging current of the first electronic device 10 charging the second electronic device 20 to generate a current detection signal. The control unit 11 determines whether the current detection signal is greater than a current threshold. When the current detection signal is greater than the current threshold, the control unit 11 determines that the charging abnormality condition occurs and generates a current abnormality record. In other words, the charging abnormality condition is an overcurrent, and the control unit 11 stores the current abnormality record in the register 14. In one embodiment, the first electronic device 10 may be provided with one of the voltage detection unit 12 and the current detection unit 13.

When an overvoltage and an overcurrent occur during the charging process of the first electronic device 10 charging the second electronic device 20, a charging abnormality record stored in the register 14 comprises a voltage abnormality record and a current abnormality record. The image processing unit 2 obtains the charging abnormality record from the register 14 of the power transmission unit 1 and stores the charging abnormality record. After the image processing unit 2 obtains the charging abnormality record from the register 14 of the power transmission unit 1, the image processing unit 2 displays the charging abnormality record through one or more of a menu displayed on a screen of the first electronic device 10 and a display operation interface of the second electronic device 20.

For example, the first electronic device 10 is a display, and the display comprises shortcuts. When a user or a maintenance engineer triggers the shortcut of the first electronic device 10, the image processing unit 2 of the first electronic device 10 obtains the charging abnormality record from the register 14 of the power transmission unit 1 via an Inter-Integrated Circuit (I2C). Next, the image processing unit 2 activates an on-screen display (OSD) menu of the screen, and the OSD menu displays the charging abnormality record. The user or the maintenance engineer can know what abnormal charging conditions have occurred during the charging process of the first electronic device 10 charging the second electronic device 20 through the charging abnormality record displayed on the OSD menu.

For example, the first electronic device 10 is a display, the second electronic device 20 is a laptop, and the laptop is installed with a display operation interface 202 and comprises a shortcut. The display operation interface 202 is an application program, and a user can adjust various parameter setting values of the first electronic device 10, such as contrast, color, brightness and resolution, through the display operation interface 202. When the user or the maintenance engineer triggers the shortcut of the second electronic device 20, the second electronic device 20 sends a request command to the first electronic device 10. Next, the image processing unit 2 of the first electronic device 10 sends a command to the second electronic device 20 based on a display data channel command interface (DDC/CI) according to the request command sent by the second electronic device 20. In one embodiment, the user may set the shortcut through a keyboard and/or a mouse hotkey combination of the second electronic device 20 to send the request command to the first electronic device 10. When the second electronic device 20 receives the command from the first electronic device 10, the display operation interface 202 of the second electronic device 20 displays the charging abnormality record. The user or the maintenance engineer can know that a charging abnormality condition occurs during the charging process from the first electronic device 10 to the second electronic device 20 through the charging abnormality record displayed on the display operation interface 202. In one embodiment, the first electronic device 10 could be monitor, television and projector. In one embodiment, the second electronic device 20 could be computer, notebook, tablet and smart phone.

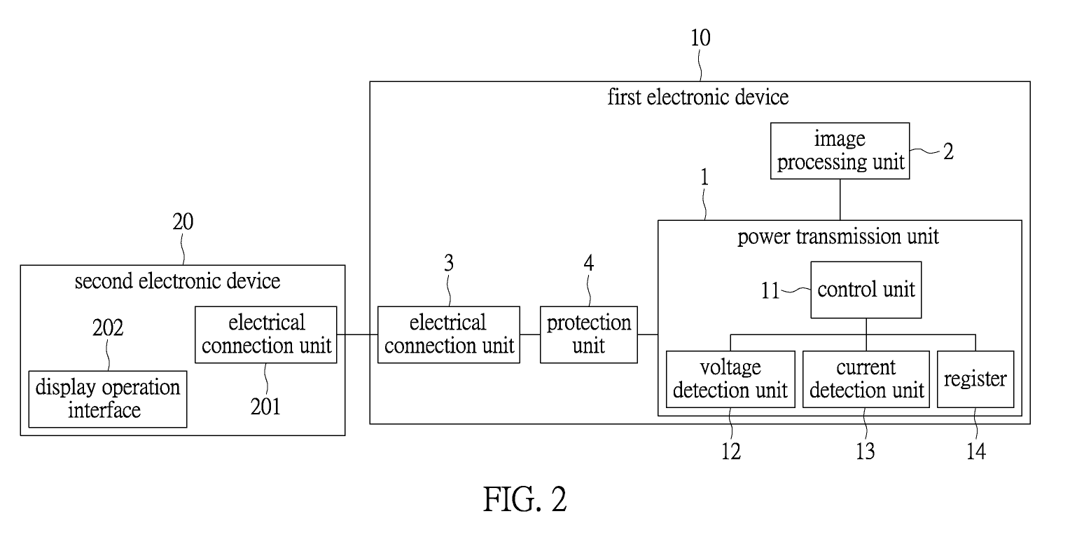

FIG. 2 is a functional block diagram of the charging abnormality detection circuit according to a second embodiment of the present disclosure. Referring to FIG. 2, the charging abnormality detection circuit comprises the power transmission unit 1, the image processing unit 2, an electrical connection unit 3 and a protection unit 4. The power transmission unit 1 is electrically connected to the image processing unit 2 and the protection unit 4, and the electrical connection unit 3 is electrically connected to the protection unit 4. It should be noted that the difference between the charging abnormality detection circuit of the second embodiment and the charging abnormality detection circuit of the first embodiment is that the charging abnormality detection circuit of the second embodiment further comprises the protection unit 4, and the protection unit 4 is electrically connected between the power transmission unit 1 and the electrical connection unit 3, the same descriptions of which will not be repeated herein.

When a charging abnormality condition occurs during the charging process of the first electronic device 10 charging the second electronic device 20, the image processing unit 2 displays the charging abnormality record through one or more of the on-screen display menu of the first electronic device 10 and the display operation interface 202 of the second electronic device 20, and the protection unit 4 transmits a charging abnormality signal to the power transmission unit 1.

The protection unit 4 is a display protection circuit, which comprises an overvoltage protection circuit and an overcurrent protection circuit. The protection unit 4 further comprises a control pin and a fault pin. A user adjusts an overvoltage protection threshold and an overcurrent protection threshold via the control pin. When the protection unit 4 detects one or more of an overvoltage condition and an overcurrent condition during the charging process, the fault pin of the protection unit 4 transmits a charging abnormality signal to the power transmission unit 1. In one embodiment, the power transmission unit 1 may be electrically connected to the electrical connection unit 3 via a voltage bus (Vbus). In one embodiment, the power transmission unit 1 may be electrically connected to the electrical connection unit 3 via a transmitter/ receiver (Tx/Rx). In one embodiment, the power transmission unit 1 may be electrically connected to the protection unit 4 via a channel configuration (CC) line, and the protection unit 4 may be electrically connected to the electrical connection unit 3 via the channel configuration line. In one embodiment, the protection unit 4 could be implemented in the power transmission unit 1. In one embodiment, the protection unit 4 could be implemented in the image processing unit 2.

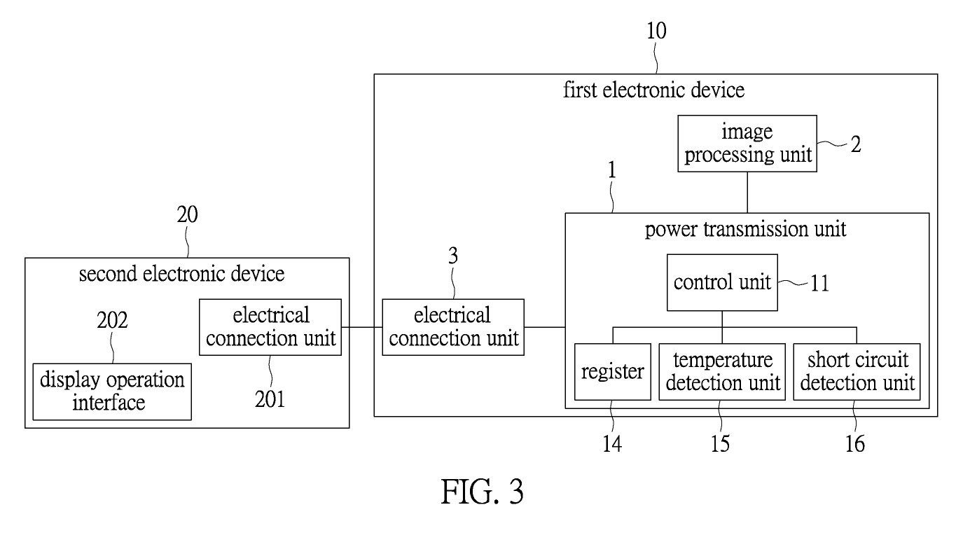

FIG. 3 is a functional block diagram of the charging abnormality detection circuit according to a third embodiment of the present disclosure. Referring to FIG. 3, the charging abnormality detection circuit comprises the power transmission unit 1, the image processing unit 2 and the electrical connection unit 3, in which the power transmission unit 1 is electrically connected to the image processing unit 2 and the electrical connection unit 3, in which the power transmission unit 1 comprises the control unit 11, the register 14, a temperature detection unit 15 and a short circuit detection unit 16, and the control unit 11 is electrically connected to the register 14, the temperature detection unit 15 and the short circuit detection unit 16. The temperature detection unit 15 is a temperature detection circuit, and the temperature detection unit 15 detects a temperature of the charging process of the first electronic device 10 charging the second electronic device 20 to generate a temperature detection signal, and the control unit 11 determines whether the temperature detection signal is greater than a temperature threshold. When the temperature detection signal is greater than the temperature threshold, the control unit 11 determines that a charging abnormality condition occurs and generates a temperature abnormality record. The control unit 11 stores the temperature abnormality record in the register 14.

The short circuit detection unit 16 is a short circuit detection circuit, and the short circuit detection unit 16 detects whether a short circuit condition occurs during the charging process of the first electronic device 10 charging the second electronic device 20. When the short circuit detection unit 16 detects that the short circuit condition occurs during the charging process, the control unit 11 determines that a charging abnormality condition occurs and generates a short circuit abnormality record, and the control unit 11 stores the short circuit abnormality record in the register 14. In one embodiment, the temperature detection unit 15 determines whether the charging abnormality condition occurs earlier than the short circuit detection unit 16. In one embodiment, the short circuit detection unit 16 determines whether the charging abnormality condition occurs earlier than the temperature detection unit 15. In one embodiment, the temperature detection unit 15 and the short circuit detection unit 16 simultaneously determine whether the charging abnormality condition occurs.

For example, when the short circuit detection unit 16 detects that a voltage bus (Vbus) pin and a CC1 pin of the electrical connection unit 3 are short circuited or the Vbus pin and a sideband use (SBU) pin are short circuited, the control unit 11 determines that a charging abnormality condition occurs and generates a short circuit abnormality record. In one embodiment, the first electronic device 10 may also be provided with any combination of at least one of the temperature detection unit 15, the short circuit detection unit 16, the voltage detection unit 12 and the current detection unit 13.

When the charging abnormality condition comprises a temperature abnormality condition and a short circuit condition, the charging abnormality record stored in the register 14 comprises a temperature abnormality record and a short circuit abnormality record. After the image processing unit 2 obtains the temperature abnormality record and the short circuit abnormality record from the register 14 of the power transmission unit 1, the image processing unit 2 displays the temperature abnormality record and the short circuit abnormality record through one or more of an on-screen display (OSD) menu of the first electronic device 10 and the display operation interface 202 of the second electronic device 20. In one embodiment, the protection unit 4 could be implemented in the power transmission unit 1. In one embodiment, the protection unit 4 could be implemented in the image processing unit 2.

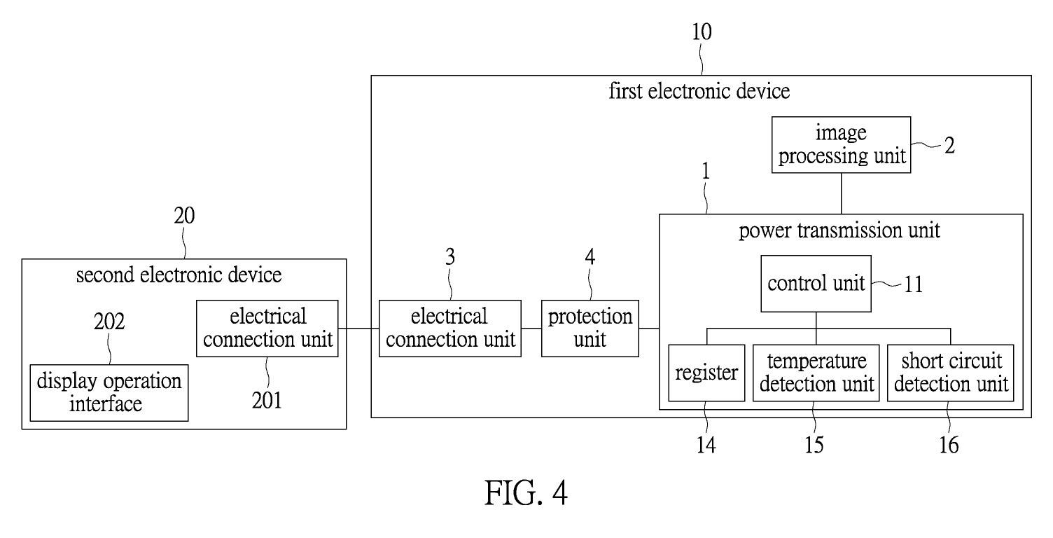

FIG. 4 is a functional block diagram of the charging abnormality detection circuit according to a fourth embodiment of the present disclosure. The difference between FIG. 4 and FIG. 3 is that the charging abnormality detection circuit further comprises the protection unit 4, and the protection unit 4 is electrically connected between the power transmission unit 1 and the electrical connection unit 3.

The protection unit 4 is a display protection circuit, which comprises a high temperature protection circuit and a short circuit protection circuit. The protection unit 4 further comprises a control pin and a fault pin. A user adjusts the temperature protection threshold via the control pin. When the protection unit 4 detects that one or more of an over-temperature condition and short circuit condition occurs during the charging process, the fault pin of the protection unit 4 transmits a charging abnormality signal to the power transmission unit 1. In one embodiment, the power transmission unit 1 may be electrically connected to the electrical connection unit 3 via a voltage bus (Vbus). In one embodiment, the power transmission unit 1 may be electrically connected to the electrical connection unit 3 via a transmitter and/or a receiver (Tx/Rx). In one embodiment, the power transmission unit 1 may be electrically connected to the protection unit 4 via a channel configuration (CC) line, and the protection unit 4 may be electrically connected to the electrical connection unit 3 via the channel configuration line. In one embodiment, the protection unit 4 could be implemented in the power transmission unit 1. In one embodiment, the protection unit 4 could be implemented in the image processing unit 2.

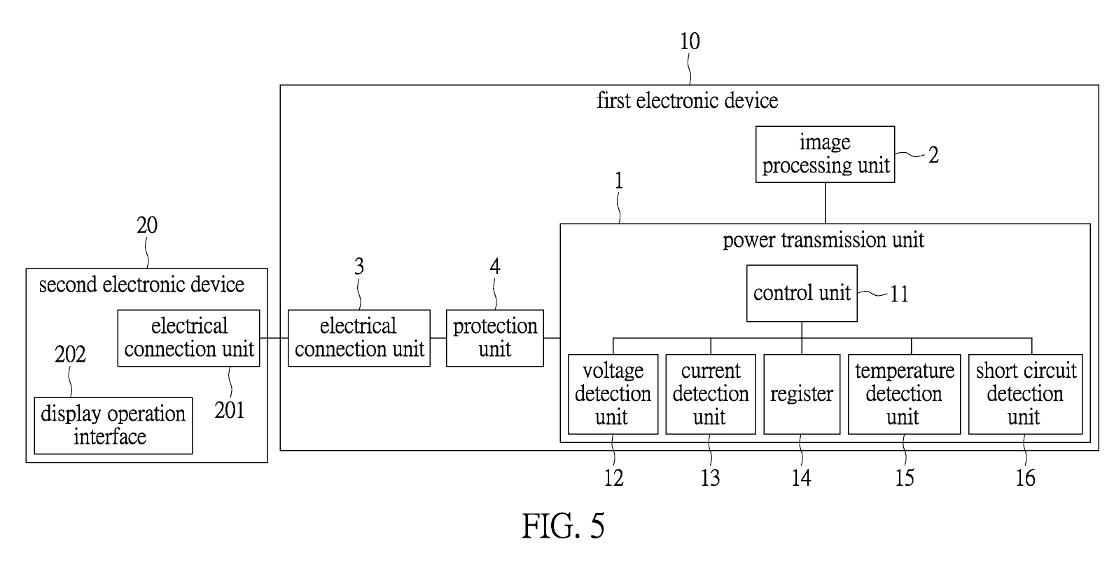

FIG. 5 is a functional block diagram of the charging abnormality detection circuit according to a fifth embodiment of the present disclosure. Referring to FIG. 5, the charging abnormality detection circuit comprises the power transmission unit 1, the image processing unit 2, the electrical connection unit 3 and the protection unit 4. The power transmission unit 1 is electrically connected to the image processing unit 2 and the protection unit 4, and the electrical connection unit 3 is electrically connected to the protection unit 4. The power transmission unit 1 comprises the control unit 11, the voltage detection unit 12, the current detection unit 13, the register 14, the temperature detection unit 15 and the short circuit detection unit 16. The control unit 11 is electrically connected to the voltage detection unit 12, the current detection unit 13, the register 14, the temperature detection unit 15 and the short circuit detection unit 16. The protection unit 4 is electrically connected between the power transmission unit 1 and the electrical connection unit 3. When the power transmission unit 1 detects that an abnormality condition occurs in the charging process of the first electronic device 10 charging the second electronic device 20, the control unit 11 determines that a charging abnormality condition occurs and generates a charging abnormality record, and the control unit 11 stores the charging abnormality record in the register 14. The charging abnormality condition is one or more of an overvoltage condition, an overcurrent condition, a high temperature condition and a short circuit condition. In one embodiment, the first electronic device 10 may also be provided with any combination of the voltage detection unit 12, the current detection unit 13, the temperature detection unit 15, and the short circuit detection unit 16. The order of determining the charging abnormality condition may be adjusted arbitrarily, or they can be performed synchronously. In one embodiment, the electrical connection unit 3 may be a high-definition multimedia interface (HDMI), a digital visual interface (DVI), a display port (DP) or a high-performance Internet cable (CAT 5/5e/6/6A/7).

The protection unit 4 is a display protection circuit, which comprises an overvoltage protection circuit, an overcurrent protection circuit, a high temperature protection circuit and a short circuit protection circuit. The protection unit 4 also comprises a control pin and a fault pin. A user adjusts an overvoltage protection threshold, an overcurrent protection threshold and a temperature protection threshold through the control pin. When the protection unit 4 detects one or more of an overvoltage condition, an overcurrent condition, an overtemperature condition and a short circuit condition during the charging process, the fault pin of the protection unit 4 transmits a charging abnormality signal to the power transmission unit 1. In one embodiment, the protection unit 4 could be implemented in the power transmission unit 1. In one embodiment, the protection unit 4 could be implemented in the image processing unit 2.

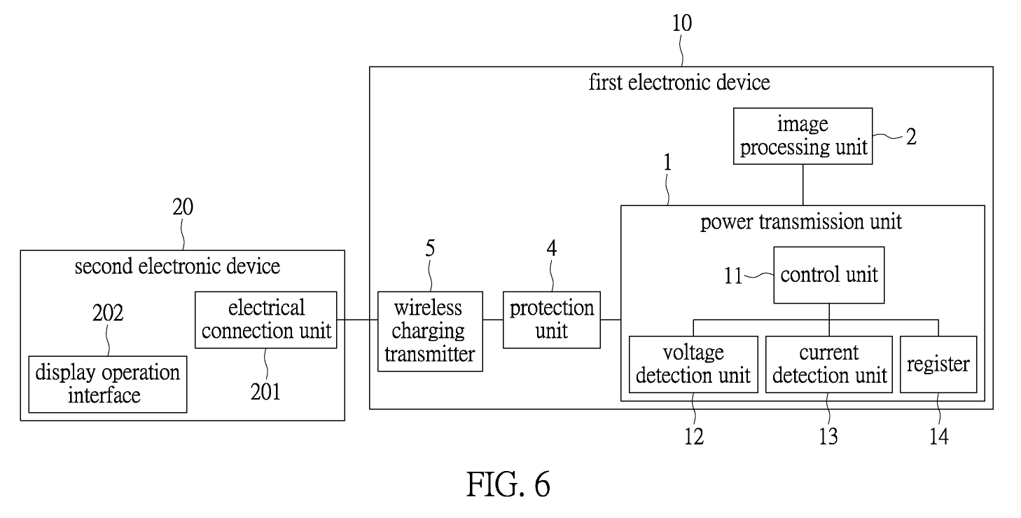

FIG. 6 is a functional block diagram of the charging abnormality detection circuit according to a sixth embodiment of the present disclosure. Referring to FIG. 6, the charging abnormality detection circuit comprises the power transmission unit 1, the image processing unit 2, the protection unit 4 and a wireless charging transmitter 5. The power transmission unit 1 is electrically connected to the image processing unit 2 and the protection unit 4, and the wireless charging transmitter 5 is electrically connected to the protection unit 4. The wireless charging transmitter 5 comprises, for example, a processor, a radio frequency circuit, a baseband circuit, a media access control circuit, and a transmitter antenna. The processor is connected to the media access control circuit, the media access control circuit is connected to the baseband circuit, the baseband circuit is connected to the radio frequency circuit, and the radio frequency circuit is connected to the transmitter antenna. A signal outputted by the processor is processed in sequence by the media access control circuit, the baseband circuit and the radio frequency circuit to generate a radio frequency signal, and the transmitter antenna sends the radio frequency signal.

The second electronic device 20 comprises a wireless charging receiver 203, and the wireless charging receiver 203 comprises, for example, a processor, a radio frequency circuit, a baseband circuit, a media access control circuit, and a receiver antenna. The processor is connected to the media access control circuit, the media access control circuit is connected to the baseband circuit, the baseband circuit is connected to the radio frequency circuit, and the radio frequency circuit is connected to the receiver antenna.

The wireless charging transmitter 5 of the first electronic device 10 and the wireless charging receiver 203 of the second electronic device 20 perform a charging process via a resonant wireless transmission mechanism. When the power transmission unit 1 detects a charging abnormality condition during the charging process, the power transmission unit is configured to generate and store a charging abnormality record. In one embodiment, the wireless charging transmitter 5 may include wireless communication protocols such as Wi-Fi, Bluetooth, Zigbee, Thread, Z-Wave and Matter.

The protection unit 4 is a display protection circuit, which comprises an overvoltage protection circuit and an overcurrent protection circuit. The protection unit 4 further comprises a control pin and a fault pin. A user adjusts an overvoltage protection threshold and an overcurrent protection threshold via the control pin. When the protection unit 4 detects one or more of an overvoltage condition and an overcurrent condition during the charging process, the fault pin of the protection unit 4 transmits a charging abnormality signal to the power transmission unit 1.

After the image processing unit 2 obtains the charging abnormality record from the power transmission unit 1, the image processing unit 2 displays the charging abnormality record through one or more of an on-screen display menu of the first electronic device 10 and a display operation interface 202 of the second electronic device 20. In one embodiment, the protection unit 4 could be implemented in the power transmission unit 1. In one embodiment, the protection unit 4 could be implemented in the image processing unit 2.

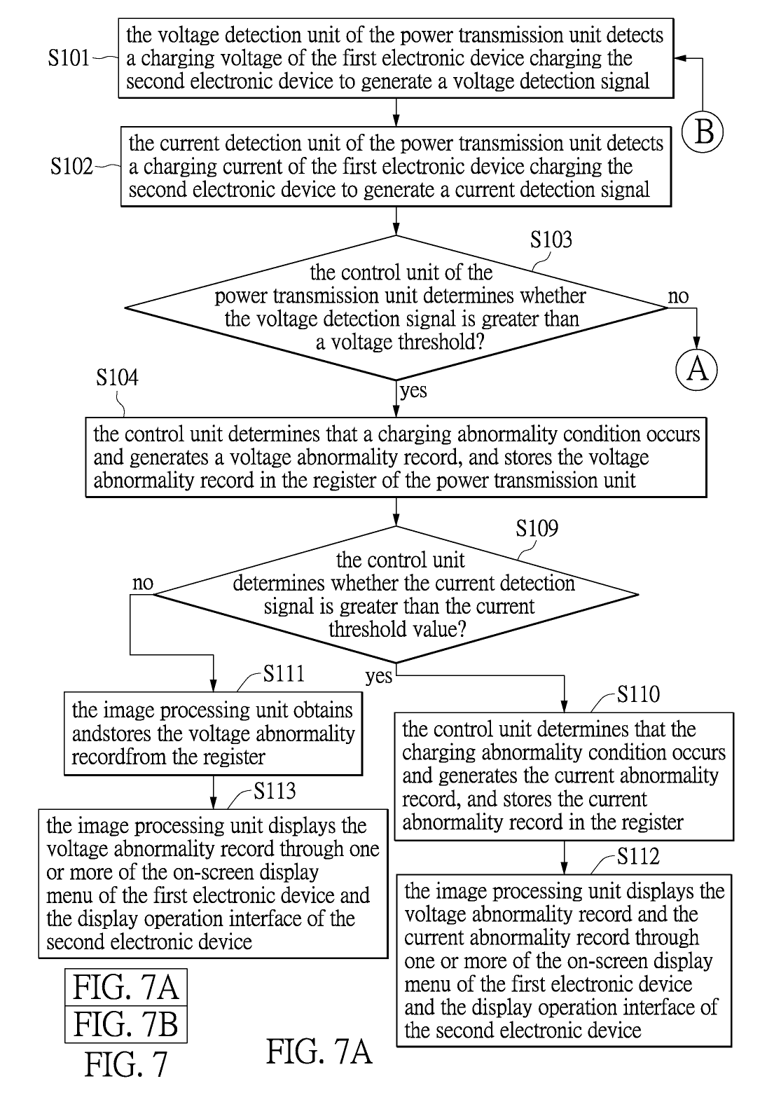

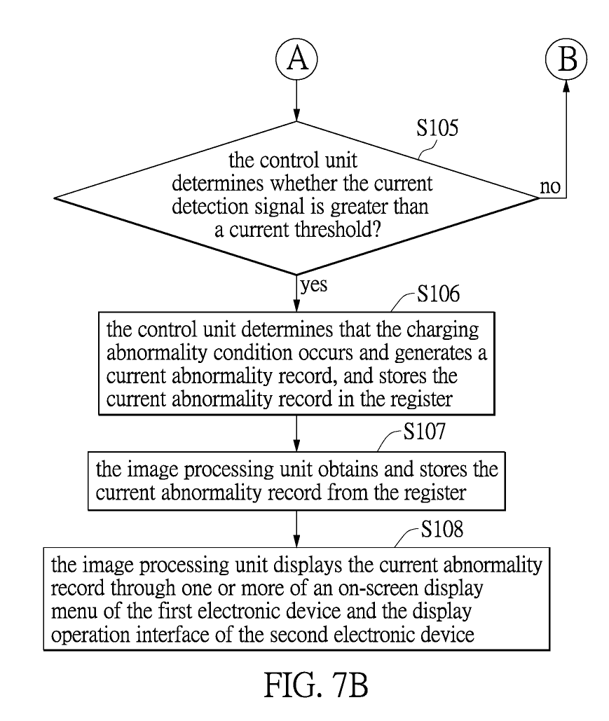

FIG. 7(FIG. 7A and FIG. 7B) is a flowchart of a charging abnormality detection method according to the first embodiment of the present disclosure. Referring to FIG. 7(FIG. 7A and FIG. 7B), in step S101, the voltage detection unit 12 of the power transmission unit 1 detects a charging voltage of the first electronic device 10 charging the second electronic device 20 to generate a voltage detection signal.

In step S102, the current detection unit 13 of the power transmission unit 1 detects a charging current of the first electronic device 10 charging the second electronic device 20 to generate a current detection signal.

In step S103, the control unit 11 of the power transmission unit 1 determines whether the voltage detection signal is greater than a voltage threshold. If so, the method proceeds to step S104; if not, the method proceeds to step S105.

In step S104, the control unit 11 determines that a charging abnormality condition occurs and generates a voltage abnormality record, and stores the voltage abnormality record in the register 14 of the power transmission unit 1.

In step S105, the control unit 11 determines whether the current detection signal is greater than a current threshold. If so, the method proceeds to step S106; if not, the method returns to step S101. In one embodiment, step S102 may be located between step S103 and step S105.

In step S106, the control unit 11 determines that the charging abnormality condition occurs and generates a current abnormality record, and stores the current abnormality record in the register 14.

Step S107 is subsequent to step S106. In step S107, the image processing unit 2 obtains and stores the current abnormality record from the register 14.

In step S108, the image processing unit 2 displays the current abnormality record through one or more of an on-screen display menu of the first electronic device 10 and the display operation interface 202 of the second electronic device 20. Specifically, the image processing unit 2 sends a command to the second electronic device 20 based on the display data channel command interface according to a request command of the second electronic device 20. When the second electronic device 20 receives the command sent by the image processing unit 2, the display operation interface 202 of the second electronic device 20 displays the current abnormality record.

Step S109 is subsequent to step S104. In step S109, the control unit 11 determines whether the current detection signal is greater than the current threshold value. If so, the method proceeds to step S110; if not, the method proceeds to step S111.

In step S110, the control unit 11 determines that the charging abnormality condition occurs and generates the current abnormality record, and stores the current abnormality record in the register 14.

In step S111, the image processing unit 2 obtains and stores the voltage abnormality record from the register 14. In one embodiment, step S111 may be located between step S104 and step S109.

Step S112 is subsequent to step S110. In step S112, the image processing unit 2 displays the voltage abnormality record and the current abnormality record through one or more of the on-screen display menu of the first electronic device 10 and the display operation interface 202 of the second electronic device 20. Specifically, the image processing unit 2 sends a command to the second electronic device 20 based on the display data channel command interface according to the request command of the second electronic device 20. When the second electronic device 20 receives the command sent by the image processing unit 2, the display operation interface 202 of the second electronic device 20 displays the voltage abnormality record and the current abnormality record.

Step S113 is subsequent to step S111. In step S113, the image processing unit 2 displays the voltage abnormality record through one or more of the on-screen display menu of the first electronic device 10 and the display operation interface 202 of the second electronic device 20. Specifically, the image processing unit 2 sends a command to the second electronic device 20 based on the display data channel command interface according to the request command of the second electronic device 20. When the second electronic device 20 receives the command sent by the image processing unit 2, the display operation interface 202 of the second electronic device 20 displays the voltage abnormality record.

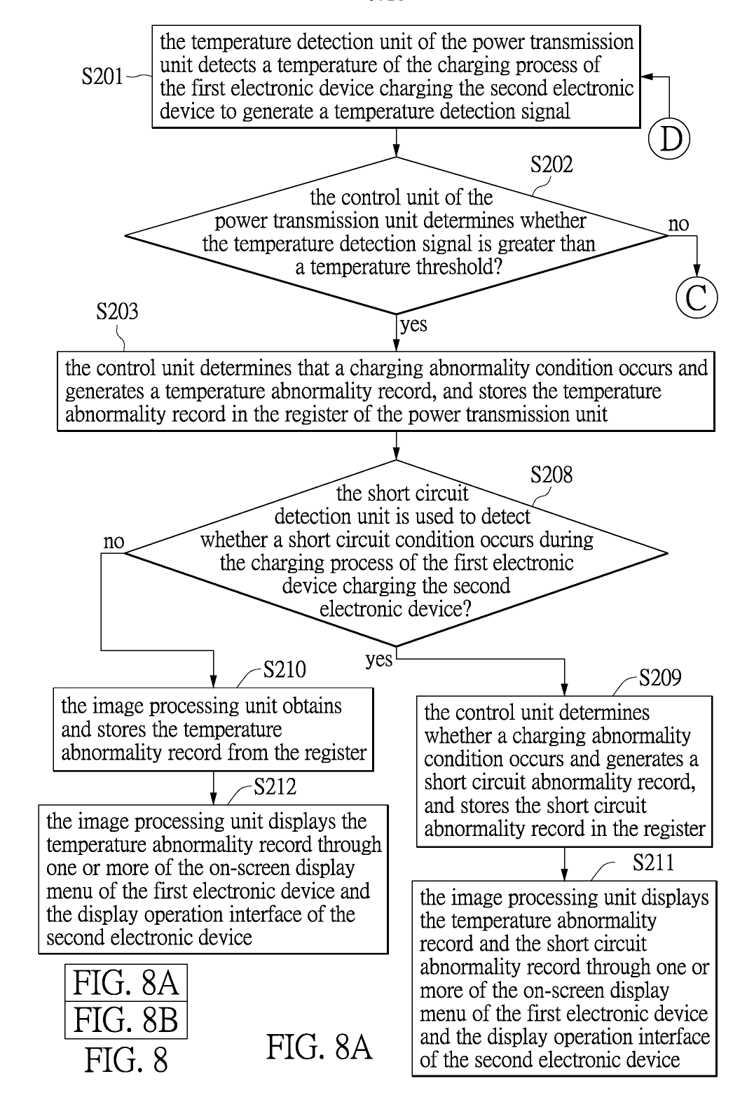

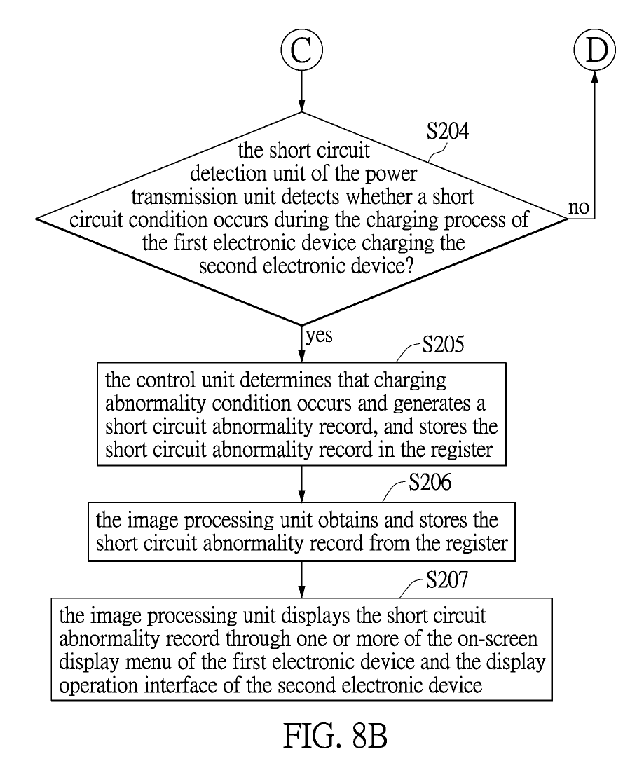

FIG. 8 (FIG. 8A and FIG. 8B) is a flowchart of the charging abnormality detection method according to the second embodiment of the present disclosure. Referring to FIG. 8 (FIG. 8A and FIG. 8B), in step S201, the temperature detection unit 15 of the power transmission unit 1 detects a temperature of the charging process of the first electronic device 10 charging the second electronic device 20 to generate a temperature detection signal.

In step S202, the control unit 11 of the power transmission unit 1 determines whether the temperature detection signal is greater than a temperature threshold. If so, the method proceeds to step S203; if not, the method proceeds to step S204.

In step S203, the control unit 11 determines that a charging abnormality condition occurs and generates a temperature abnormality record, and stores the temperature abnormality record in the register 14 of the power transmission unit 1.

In step S204, the short circuit detection unit 16 of the power transmission unit 1 detects whether a short circuit condition occurs during the charging process of the first electronic device 10 charging the second electronic device 20. If so, the method proceeds to step S205; if not, the method returns to step S201.

In step S205, the control unit 11 determines that charging abnormality condition occurs and generates a short circuit abnormality record, and stores the short circuit abnormality record in the register 14.

In step S206, the image processing unit 2 obtains and stores the short circuit abnormality record from the register 14.

In step S207, the image processing unit 2 displays the short circuit abnormality record through one or more of the on-screen display menu of the first electronic device 10 and the display operation interface 202 of the second electronic device 20. Specifically, the image processing unit 2 sends a command to the second electronic device 20 based on the display data channel command interface according to the request command of the second electronic device 20. When the second electronic device 20 receives the command sent by the image processing unit 2, the display operation interface 202 of the second electronic device 20 displays the short circuit abnormality record.

Step S208 is subsequent to step S203. In step S208, the short circuit detection unit 16 is used to detect whether a short circuit condition occurs during the charging process of the first electronic device 10 charging the second electronic device 20. If so, the method proceeds to step S209; if not, the method proceeds to step S210.

In step S209, the control unit 11 determines whether a charging abnormality condition occurs and generates a short circuit abnormality record, and stores the short circuit abnormality record in the register 14.

In step S210, the image processing unit 2 obtains and stores the temperature abnormality record from the register 14. In one embodiment, step S210 may be located between step S203 and step S208.

Step S211 is subsequent to step S209, the image processing unit 2 displays the temperature abnormality record and the short circuit abnormality record through one or more of the on-screen display menu of the first electronic device 10 and the display operation interface 202 of the second electronic device 20. Specifically, the image processing unit 2 sends a command to the second electronic device 20 based on the display data channel command interface according to the request command of the second electronic device 20. When the second electronic device 20 receives the command sent by the image processing unit 2, the display operation interface 202 of the second electronic device 20 displays the temperature abnormality record and the short circuit abnormality record.

In step S212, the image processing unit 2 displays the temperature abnormality record through one or more of the on-screen display menu of the first electronic device 10 and the display operation interface 202 of the second electronic device 20. Specifically, the image processing unit 2 sends a command to the second electronic device 20 based on the display data channel command interface according to the request command of the second electronic device 20. When the second electronic device 20 receives the command sent by the image processing unit 2, the display operation interface 202 of the second electronic device 20 displays the temperature abnormality record.

In another embodiment, the charging abnormality detection method can be any combination of at least one of step S103 (determining whether the voltage detection signal is greater than the voltage threshold), step S105 (determining whether the current detection signal is greater than the current threshold), step S202 (determining whether the temperature detection signal is greater than the temperature threshold), and step S204 (determining whether a short circuit condition occurs), and the order thereof can be adjusted arbitrarily or they can be executed simultaneously.

### Beneficial Effects of the Embodiments

In conclusion, the charging abnormality detection circuit and the charging abnormality detection method provided by the present disclosure allows a user to know whether abnormal conditions occur during the charging process during the charging process of the electronic device. When the user is made aware of the abnormal conditions during the charging process, the user can stop the charging process immediately to avoid damage to the electronic device.

In one embodiment, the charging abnormality detection circuit and the charging abnormality detection method help to collect adverse information when a USB type C port of a display product encounters adverse conditions during use by clients or on the market, thereby assisting in subsequent analysis and debugging.

In one embodiment, the present disclosure proposes a detection circuit and recording method for whether a USB-C monitor of PD power output experiences voltage/current/temperature/short circuit anomalies, which allows maintenance units or users to check or be reminded that a potential USB type C port burnout condition has occurred, helping to clarify whether it has to do with the user's operating environment (paired with PC/NB) or other problems. This will be helpful for the increasing number of USB type C PD power supply applications and compatibility/operability conditions.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A charging abnormality detection circuit, mounted in a first electronic device, and the charging abnormality detection circuit comprising:
an image processing unit; and
a power transmission unit electrically connected to the image processing unit, wherein the power transmission unit provides a charging process from the first electronic device to a second electronic device and detects whether a charging abnormality condition occurs during the charging process;
wherein the power transmission unit generates and stores a charging abnormality record in response to the charging abnormality condition being detected by the power transmission unit during the charging process.

2. The charging abnormality detection circuit according to claim 1, wherein the image processing unit obtains and stores the charging abnormality record from the power transmission unit, and the image processing unit displays the charging abnormality record through a menu displayed on a screen of the first electronic device and/or through a display operation interface of the second electronic device.

3. The charging abnormality detection circuit according to claim 1, wherein the power transmission unit comprises a register for storing the charging abnormality record, and the image processing unit obtains and stores the charging abnormality record from the register.

4. The charging abnormality detection circuit according to claim 1, wherein the image processing unit sends a command based on a display data channel command interface, so as to transmit the charging abnormality record to the second electronic device according to a request command of the second electronic device, and the second electronic device displays the charging abnormality record.

5. The charging abnormality detection circuit according to claim 1, wherein the power transmission unit comprises a control unit, a voltage detection unit and a current detection unit; wherein the control unit is electrically connected to the voltage detection unit and the current detection unit, the voltage detection unit detects a charging voltage of the charging process to generate a voltage detection signal, and the current detection unit detects a charging current of the charging process to generate a current detection signal; wherein the control unit determines whether the voltage detection signal is greater than a voltage threshold, and when the voltage detection signal is greater than the voltage threshold, the control unit determines that the charging abnormality condition occurs during the charging process and generates a voltage abnormality record; wherein the control unit further determines whether the current detection signal is greater than a current threshold, and when the current detection signal is greater than the current threshold, the control unit determines that the charging abnormality condition occurs and generates a current abnormality record; and wherein the charging abnormality record comprises the voltage abnormality record and the current abnormality record.

6. The charging abnormality detection circuit according to claim 1, wherein the power transmission unit further comprises a control unit, a temperature detection unit and a short circuit detection unit, the control unit is electrically connected to the temperature detection unit and the short circuit detection unit, the temperature detection unit detects a temperature of the charging process to generate a temperature detection signal, and the control unit determines whether the temperature detection signal is greater than a temperature threshold, when the temperature detection signal is greater than the temperature threshold, the control unit determines that the charging abnormality condition occurs and generates a temperature abnormality record, the short circuit detection unit is configured to detect whether a short circuit occurs during the charging process of the first electronic device to the second electronic device, when the short circuit detection unit detects that the short circuit occurs during the charging process, the control unit determines that the charging abnormality condition occurs and generates a short circuit abnormality record, the charging abnormality record further comprises the temperature abnormality record and the short circuit abnormality record.

7. The charging abnormality detection circuit according to claim 1, further comprising an electrical connection unit and a protection unit, wherein the electrical connection unit is electrically connected to the second electronic device through a charging cable, and the protection unit is electrically connected between the electrical connection unit and the power transmission unit.

8. The charging abnormality detection circuit according to claim 7, wherein, when the charging abnormality condition occurs during the charging process, the protection unit transmits a charging abnormality signal to the power transmission unit.

9. The charging abnormality detection circuit according to claim 1, further comprising a wireless charging transmitter and a protection unit, and wherein the second electronic device comprises a wireless charging receiver; wherein the wireless charging transmitter and the wireless charging receiver perform the charging process through a resonant wireless transmission mechanism, and the protection unit is electrically connected to the wireless charging transmitter and the power transmission unit.

10. The charging abnormality detection circuit according to claim 9, wherein, when the charging abnormality condition occurs during the charging process, the protection unit transmits a charging abnormality signal to the power transmission unit.

11. A charging abnormality detection method, applied to a first electronic device, and the charging abnormality detection method comprising:
monitoring, by a power transmission unit of the first electronic device, a charging process from the first electronic device to a second electronic device;
detecting, by the power transmission unit, whether a charging abnormality condition occurs during the charging process; and
generating and storing, by the power transmission unit, a charging abnormality record in response to the charging abnormality condition being detected by the power transmission unit during the charging process.

12. The charging abnormality detection method according to claim 11, further comprising: obtaining and storing, by an image processing unit of the first electronic device, the charging abnormality record from the power transmission unit; and displaying the charging abnormality record through a menu displayed on a screen of the first electronic device and/or through a display operation interface of the second electronic device.

13. The charging abnormality detection method according to claim 11, wherein the power transmission unit comprises a register for storing the charging abnormality record, and an image processing unit is configured to obtain and store the charging abnormality record from the register.

14. The charging abnormality detection method according to claim 11, further comprising: sending, by an image processing unit of the first electronic device, a command based on a display data channel command interface; transmitting, by an image processing unit, the charging abnormality record to the second electronic device according to a request command of the second electronic device in response to the image processing unit sending the command; and displaying the charging abnormality record by the second electronic device in response to the image processing unit sending the command.

15. The charging abnormality detection method according to claim 11, wherein monitoring the charging process by the power transmission unit comprises: detecting, by a voltage detection unit of the power transmission unit, a charging voltage of the charging process to generate a voltage detection signal; detecting, by a current detection unit of the power transmission unit, a charging current of the charging process to generate a current detection signal; determining, by a control unit of the power transmission unit, whether the voltage detection signal is greater than a voltage threshold; determining that the charging abnormality condition occurs during the charging process and generating a voltage abnormality record by the control unit when the voltage detection signal is greater than the voltage threshold; determining, by the control unit, whether the current detection signal is greater than a current threshold; and determining that the charging abnormality condition occurs and generating a current abnormality record by the control unit when the current detection signal is greater than the current threshold; wherein the charging abnormality record comprises the voltage abnormality record and the current abnormality record.

16. The charging abnormality detection method according to claim 11, wherein monitoring the charging process by the power transmission unit comprises: detecting, by a temperature detection unit of the power transmission unit, a temperature of the charging process to generate a temperature detection signal; determining, by a control unit of the power transmission unit, whether the temperature detection signal is greater than a temperature threshold; determining that the charging abnormality condition occurs and generating a temperature abnormality record by the control unit when the temperature detection signal is greater than the temperature threshold; detecting, by a short circuit detection unit of the power transmission unit, whether a short circuit occurs during the charging process; and determining that the charging abnormality condition occurs and generating a short circuit abnormality record by the control unit when the short circuit occurs during the charging process, wherein the charging abnormality record further includes the temperature abnormality record and the short circuit abnormality record.

17. The charging abnormality detection method according to claim 11, wherein the first electronic device performs the charging process on the second electronic device through an electrical connection unit and a charging cable.

18. The charging abnormality detection method according to claim 17, wherein, when the charging abnormality condition occurs during the charging process, a protection unit of the first electronic device transmits a charging abnormality signal to the power transmission unit.

19. The charging abnormality detection method according to claim 11, wherein the charging process is performed between the first electronic device and the second electronic device through a resonant wireless transmission mechanism.

20. The charging abnormality detection method according to claim 19, wherein ,when the charging abnormality condition occurs during the charging process, a protection unit of the first electronic device transmits a charging abnormality signal to the power transmission unit.
